(19) United States
(12) Patent Application Publication
(10) Pub. No.: US 2007/0196556 A1
(43) Pub. Date: Aug. 23, 2007

(54) Process For The Roasting Of Cocoa

(76) Inventor: Henricus J.J. Van Der Meer, Assendelft (NL)

Correspondence Address: FISH & RICHARDSON P.C., PO BOX 1022, MINNEAPOLIS, MN, 55440-1022, US

(21) Appl. No.: 11/572,092

(22) PCT Filed: Jul. 14, 2005
(86) PCT No.: PCT/IB05/02014

§ 371 Date: Jan. 12, 2007

(30) Foreign Application Priority Data
Jul. 15, 2004 (GB) 0415861.4

(51) Int. Cl. A47J 39/00

(52) U.S. Cl. 426/593; 426/520

(57) ABSTRACT

The invention relates to a process for roasting cocoa and to a process for the manufacture of cocoa liquor, cocoa powder and cocoa butter. The invention further relates to cocoa liquor, cocoa powder and cocoa butter obtained by the processes of the invention, their use in the manufacture of chocolate products, and to chocolate products made from the cocoa liquor or cocoa powder of the invention. The process for roasting cocoa comprises the steps of wetting cocoa nibs with at least 5 wt % water, grinding the wetted cocoa nibs to reduce the homogenizing particle size of the nibs to produce ground nibs, shaping the ground nibs to form shaped agglomerated cocoa particles, and roasting the shaped agglomerated cocoa particles at a temperature of between 80 and 160° C. The process is economic and the roasted cocoa and the cocoa powder or cocoa liquor made therefrom have improved color and taste and also have a low acrylamide content.

The invention relates to a process for the roasting of cocoa and to a process for the manufacture of cocoa liquor, cocoa powder and cocoa butter. The invention further relates to cocoa liquor, cocoa powder and cocoa butter obtainable in the process according to the invention and their use in the manufacture of chocolate products.

Cocoa is the main and essential ingredient for making chocolate and cocoa powder is used in various consumer products to provide a chocolate taste. As described in U.S. Pat. No. 5,635,183, for the production of cocoa powder, the cocoa nibs are often treated with a solution containing a base, typically an alkali solution, to provide a more attractive, brighter and more intense red colour. This process is called alkalising. After alkalising, the cocoa nibs are dried and subsequently roasted to develop a more attractive odour and taste profile. It is believed that during roasting at elevated temperature reactions occur, the so-called Maillard reactions, in which reducing sugars and amino acids react causing the development of a characteristic taste and odour profile. The roasted cocoa nibs are subsequently ground at elevated temperatures to release the cocoa butter contained in the cocoa nibs, producing cocoa liquor. The cocoa powder is obtained by separating the cocoa butter from the cocoa liquor, for example by pressing and/or extraction. The cocoa powder can be used to provide a chocolate taste to consumer products. The cocoa butter can be added together with sugar and milk solids to cocoa liquor to manufacture chocolate.

A disadvantage of the processes of the prior art for roasting of cocoa is that a relatively long time and relatively high temperatures are required to achieve an attractive taste and odour profile. Apart from the long process disadvantage it has been found that a long exposure to high temperatures during roasting also leads to the formation of acrylamides, which are suspected of being carcinogenic. A further disadvantage of the prior art processes is that over-roasting adversely affects the quality of the cocoa butter, in particular when the cocoa nibs are alkalised before roasting. The solidification characteristics of chocolate, e.g. the speed of crystallisation, decreases if cocoa butter is used from cocoa nibs with a high level of roasting. Further, over-roasting leads to a high level of degradation products and impurities. A reduced crystallisation speed implies poorer mould release properties and reduced production capacity in series production of shaped chocolate articles, like for example Easter bunnies.

It is the object of the present invention to provide a process for the roasting of cocoa that does not have the above-mentioned disadvantages. In particular, the object of the invention is to provide a roasting process resulting in lower acrylamide levels in the resulting cocoa powder and cocoa liquor. A further object of the invention is to provide a roasting process that is simpler, more economic and attractive from a process technical point of view. Further, as there is a continuous desire to improve the attractiveness of chocolate and cocoa containing products, it is the object of the invention to provide a cocoa roasting process resulting in to cocoa powder having a consistently better taste and odour profile and a more attractive, brighter and intense red colour and cocoa butter from alkalised cocoa nibs having improved crystallisation speed.

In view of the above described objects there is provided according to the invention a process for the roasting of cocoa nibs comprising the steps of wetting cocoa nibs with water up to a water content of at least 5 wt %, grinding the wetted cocoa nibs, thus reducing and homogenising particle size of the nibs, shaping the ground nibs to form shaped agglomerated cocoa particles, and roasting the shaped agglomerated cocoa particles at a temperature between 80 and 160° C.

It was found that with the process according to the invention cocoa powder could be obtained with a better taste and brighter and more intense red colour, which scored substantially better in consumer tasting test of panels. On the other hand the acrylamide content could be held considerably lower. It was found that the cocoa nibs, after wetting with water, could be ground and reduced in size without substantial releasing of the cocoa butter contained in the nibs. This was surprising because the cocoa nibs contain about 50 wt % cocoa butter contained in micro-cells of the bean and, on grinding, these micro-cells normally quickly release the cocoa butter, turning the ground nibs into a pasty viscous cocoa liquor mass. It is considered essential that in the process according to the invention the beans are wetted with a sufficient amount of water for sufficient time to make the hard parts of the bean flexible thus preventing the release of the cocoa butter during grinding. The water content at which this effect is obtained is at least 5 wt. %. Preferably however, the water content in the wetted cocoa nibs is between 10 and 75 wt %, more preferably at least 12 wt percent, most preferably at least 15 or even at least 20 wt percent. It is preferred that in the process according to the invention the water content in the wetted cocoa nibs is equal to or less than the maximum amount of water than can be absorbed by the cocoa nibs. This maximum amount usually is about 50 wt %. The advantage is that no water separation step is required, no ingredients are lost and no wastewater is generated.

In a preferred embodiment the wetted nibs are heated (cooked) to a temperature above 50° C. to accelerate the absorption of water in the hard cell parts of the cocoa nibs and in particular in case the cocoa nibs are to be alkalised to speed up the alkalisation reaction. The heating can be done by adding heated water or alkali solution, by a double heated jacket or by supplying hot steam direct into the product mix. Preferably the temperature is at least 70° C., more preferably at least 80° C. and most preferably at least 90° C. to effect simultaneous sterilisation of the cocoa nibs. The time required to reach sufficient water absorption by the cocoa nibs depends on the amount of water and the temperature and can be easily determined by the skilled man having regard to the above teaching. Typically the time is at least 0.5 h, preferably at least 0.75 h, more preferably at least 1 h.

Although the cocoa nibs can be ground and shaped in separate process steps it is in view of process economy preferred that the cocoa nibs are ground and shaped in one operational step. It was found that good results can be obtained also when grinding and shaping is done in one operation step in for example a pelletiser or an extruder. To prevent the release of the cocoa butter from the cocoa nibs it is preferred that the temperature during the grinding and shaping is below 100° C. As the temperature during grinding may rise because of mechanical friction care should be taken that the temperature does not rise locally unnoticed. It was found that addition of a sufficient amount of water can effectively prevent an undesired temperature rise. The required amount of water depends on the process conditions and equipment and can be established by routine experimentation using the guidelines described above.

A further advantage of the process according to the invention is that an effective roasting of the cocoa in the shaped agglomerated cocoa particles can be obtained at moderate temperature conditions even when the roasting is performed in the presence of a substantial amount of water. This obviates the necessity of a drying step before the roasting step. Therefore, a preferred embodiment of the process according to the invention, does not contain a drying step before the roasting step and the shaped agglomerated cocoa particles are simultaneously dried during roasting.

In view of obtaining roasted shaped agglomerated cocoa particles having a low acrylamide content it is, however, preferred that the water content at any time during the roasting is at least 0.5 w % and the water activity value is at least 0.05. Then water content is preferably at least 1, more preferably at least 1.5 and even more preferably at least 1.75 and most preferably at least 2 wt %. The water activity value is preferably at least 0.1, more preferably at least 0.15, most preferably at least 0.2. Ideally, the water content at any time during the roasting is at least 1 w % and the water activity value is at least 0.1. In view of the same objective to achieve a low acrylamide content, it is further preferred that the temperature of the roasting is between 70 and 135° C., preferably between 80 and 120° C., more preferably between 90 and 110° C. It was found that despite these low roasting temperatures of the shaped agglomerated cocoa particles an acceptable or excellent roasted product can be achieved.

In pelletising or extrusion the shaped agglomerated cocoa particles have a cylindrical shape preferably having a diameter of between 1 and 5 millimetres. The particle size of the cocoa nibs in the shaped agglomerated cocoa particles is considerably reduced. Preferably, the average particle size of the cocoa nibs in the shaped agglomerated cocoa particle is less than 50%, preferably less than 30%, more preferably less than 20% and most preferably less than 10% of the average particle size of the cocoa nibs before grinding. Accordingly, a lower shaped particle diameter is preferred in view of obtaining improved roasting properties according to the invention. A higher particle diameter is however preferred in view of obtaining sufficient particle strength and good particle handling properties. Preferably, the particle diameter is between 2 and 4 millimetres. The length of the shaped agglomerated cocoa particles typically is between 3 and 10 mm. The ratio of length over diameter of the shaped particles is preferably between one and eight, more preferably between one and five in view of sufficient particle strength and bulk handling properties.

It was found that the roasting properties according to the invention are favourably influenced when the shaped agglomerated cocoa particles have a relatively high porosity. On the other hand high porosity also implies low shaped particle strength. It was found that a good particle strength and excellent roasting properties could be obtained in the process according to the invention if the cocoa nibs are shaped in a die having cylindrical holes with a compression (defined as the ratio of the length over the diameter of the hole) of between 3 and 30, preferably between 5 and 25, most preferably between 7 and 15. In a preferred embodiment the cocoa nibs are ground and shaped in one operational step in a pelletiser having a die with holes having a compression of between 5 and 25 and a diameter of between 2 and 4 mm. It is further preferred that the holes in the die have a conically shaped entry opening, preferably over at least 0.5 mm at an angle with the holes' cylindrical axis of between 30 and 75 degrees. The advantage is that the residence time of the cocoa nibs in the pelletiser is reduced, higher throughput is achieved and the risk of releasing cocoa butter during grinding is reduced.

As described above cocoa nibs are often alkalised to improve the brightness and intensity of the red colour of the cocoa powder. Accordingly, in one embodiment of the process of the invention the cocoa nibs or shaped agglomerated cocoa particles are contacted with a base for alkalising the cocoa. It is preferred that the base is added with the water in the wetting of the cocoa nibs before grinding and shaping. In this way a good mixing, contacting and impregnation of the cocoa nibs with the base is achieved resulting in an improved cocoa powder properties as will be described in more detail below. The shaped agglomerated cocoa particles containing a base after the wetting are preferably kept at a temperature between 50 and 120° C. for a time sufficient to at least partially complete the alkalising reaction and are subsequently roasted at a higher temperature between 80 and 160° C. It was found that a higher quality cocoa butter could be obtained in case the alkalising reaction is performed at a lower temperature than the roasting temperature. It is preferred that substantially all base has reacted and the alkalising reaction is as complete as possible before raising the temperature for roasting.

The invention also relates to shaped agglomerated cocoa particles obtainable by a process according to the invention, in particular to shaped agglomerated cocoa particles having a cylindrical shape with a diameter of between 2 to 5 mm and a length of between 3 and 10 mm. The invention also relates to the use of shaped agglomerated cocoa particles comprising ground and agglomerated cocoa nibs, preferably pelletised particles, in a process for the manufacture of cocoa liquor, cocoa powder and/or cocoa butter.

The invention further also relates to a process for the manufacture of cocoa liquor, wherein the obtained roasted shaped agglomerated cocoa particles are subjected to grinding at elevated temperature to release the cocoa butter. The invention further relates to cocoa liquor obtainable according to the process according to the invention. The cocoa liquor is a viscous pasty substance used as a basic ingredient for the manufacture of chocolate. The cocoa liquor can also be further processed by extraction and/or pressing to separate the cocoa butter and cocoa powder. The temperature may be raised just by the mechanical fraction or grinding of the process. For the production of cocoa powder the cocoa nibs are preferably alkalised. As described above the alkalising generally has the disadvantage of a lower quality cocoa butter. With a lower quality is implied that the cocoa butter has a higher impurity level and more importantly has a lower crystallisation speed, expressed as a lower Q value. The Q value is defined as the slope or tangent of the crystallisation peak in a cooling curve (in a measurement of temperature as a function of time determined according to standard method ICA no 31 (former IOCCC no 110, 1988). An advantage of the present invention is that even in case of alkalising the cocoa nibs, a good quality cocoa butter is obtained. Preferably, in the process of the invention the decrease in Q value caused by alkalising is less than 0.03° C./min, more preferably less than 0.02° C./min and most preferably less than 0.01° C./min.

In particular, the invention relates to shaped agglomerated cocoa particles or cocoa liquor wherein the acrylamide content is below 350 parts per billion (ppb), preferably below 200 ppb, more preferably below 140 ppb, even more preferably below 120 ppb and most preferably below 75 ppb. The invention further also relates to cocoa butter obtainable according to process of the invention from alkalised shaped agglomerated cocoa particles, wherein the cocoa butter has a Q value of at least 0.15° C./min, more preferably at least 0.2° C./min, even more preferably at least 0.25° C./min. In particular, the cocoa butter according to the invention has a Q value of less than 50%, preferably less than 20% below the Q value of natural cocoa butter obtainable in the same process without alkalisation.

The cocoa powder obtained in the process according to the invention involving an alkalisation step has an excellent quality both in terms of attractive colour and taste as well as a low acrylamide content. The colour is expressed in the Oetker value. A high Oetker value correlates highly with a high consumer quality appreciation and is determined by measuring the colour of the Cocoa powder in a Hunter colour analyser, determining colour characteristic values L, a and b from the measurement in a known standard way and determining the Oetker value according to the formula: Oetker value=a−0.2×(L+29.7). Preferably the cocoa powder according to the invention has an Oetker value of at least 1.0, more preferably at least 1.1, even more preferably at least 1.2 and most preferably at least 1.3. The cocoa powder has an acryl amide content below 350 parts per billion (ppb), but is preferably below 200 ppb, more preferably below 150 ppb, even more preferably below 125 ppb and most preferably below 110 ppb.

The invention further relates to the use of the shaped cocoa agglomerated particles, cocoa liquor, cocoa powder or cocoa butter according to the invention for the manufacture of chocolate products and to chocolate products comprising cocoa powder, cocoa butter or cocoa liquor according to the invention.

The invention will be illustrated by the following examples without however being limited thereto.

In the experiments cocoa nibs were used from fermented African cocoa beans (40 wt % Ivory, 30 wt % Nigeria, 30 wt % Camerun). For the alkalisation an alkali solution was prepared of potassium carbonate and sodium hydroxide in a 1:1 ratio with a strength of 6.25° Bé at 20° C. 2 weight parts of cocoa nibs were mixed with 1 weight part of alkali solution and precooked by heating coming from direct steam injection in the product mix. The water content in the wetted nibs will be around 33 wt %. The wetted cocoa nibs were mixed for 45 minutes at a temperature 96-99° C. to completely absorb the alkali solution and to simultaneously sterilise the mixture.

Comparative Experiment A

The wetted cocoa nibs were cooled down to 80° C. with cold air and stored for 3 h at this temperature to complete the alkalisation reaction. The wetted cocoa nibs were subsequently dried and roasted with hot air of 180° C. to a water content between 0.5 and 1.5% ( The water activity was 0.05). The temperature of the cocoa nibs during roasting was between 80° C. (at the start of the drying/roasting) and 125° C. at the end of the roasting process, so when it had developed the right flavour.

### EXAMPLES 1 and 2

The wetted cocoa nibs were fed to a pelletiser to grind and shape them to pellets of 3 mm wide and 5 mm long. A UMT rin-pelletiser was used, with a matrix having 3 mm holes and 30 mm length and having a capacity 3000 kg/h. The temperature of the cocoa nibs in the pelletiser during pelletising was about 80° C. The temperature of the shaped agglomerated cocoa particles after pelletising was also about 80° C. The shaped agglomerated cocoa particles were subsequently simultaneously dried and roasted with hot air of 180° C. to a water content between 1.75 and 2.5% which means a water activity value of 0.1-015. Roasting was stopped when the pellets reached a temperature of 105-110° C. at the point where the right flavour was developed. The temperature of shaped agglomerated cocoa particles during roasting was between 80° C. (at the start) and 110° C. (at the finish).

After the roasting step the roasted cocoa nibs of Comparative experiment A and the roasted shaped agglomerated cocoa particles of Example 1 and 2 were ground to produce cocoa liquor and subsequently pressed to separate the cocoa butter and the cocoa powder. The obtained cocoa liquor and cocoa powder were characterised by measuring the colour characteristics L, a and b in a Hunter colour analyser according to a modified method applicable for cocoa. Light reflection of cocoa liquor is measured in liquid form at a temp of 50° C. in a suitable transparent sample holder. Light reflection of cocoa powder is measured in the same way by making liquid slurry of 1 part cocoa powder and 3 parts water. The Oetker value was derived from the colour measurements as described above.

The cocoa butter was analysed by determining the Q value from the tangent of the crystallisation peak in a cooling curve obtained by measuring the temperature of a cocoa butter sample as a function of time on cooling according to method ICA no 31 (former IOCCC no. 110, 1988).

The acrylamide content of the cocoa powder was measured using liquid chromatography connected with double mass spectrometry.

The measurement results are listed in Table 1. The measurements show that the cocoa liquor and the cocoa powder according to the invention have a much lower acrylamide content whereas on the other hand the products have a more attractive and intense red colour (higher a/b) and a brighter red colour (higher Oetker value). The cocoa butter obtained in the process according to the invention has a higher Q value indicating that it has a higher crystallisation rate.

TABLE 1

| | Comparative | | |
|---|---|---|---|
| | experiment A | Example 1 | Example 2 |
| Cocoa liquor | | | |
| L | 8.9 | 9.1 | 9 |
| A | 5.8 | 6.3 | 6.1 |
| B | 3.7 | 3.8 | 3.5 |
| a/b | 1.58 | 1.64 | 1.74 |
| Cocoa butter | | | |
| Q-value | 0.15 | 0.18 | 0.18 |
| Cocoa powder | | | |
| L | 13.3 | 13.9 | 14 |
| A | 9.5 | 10.1 | 10 |
| B | 5.8 | 6.1 | 6.1 |
| Oetker¹ | 0.9 | 1.4 | 1.3 |
| a/b | 1.63 | 1.65 | 1.65 |
| Acrylamide | 320 | 115 | 123 |
| (ppb) | | | |

1.-31. (canceled)

32. A process for roasting cocoa comprising:
a) wetting cocoa nibs with at least 5 wt % water;
b) grinding the wetted cocoa nib to reduce the homogenizing particle size of the nibs, thereby forming ground nibs;
c) shaping the ground nibs to form shaped agglomerated cocoa particles; and
d) roasting the shaped agglomerated cocoa particles at a temperature between 80° C. and 160° C.

33. The process of claim 32, wherein the water content in the wetted cocoa nibs is between 10 and 75 wt %.

34. The process of claim 32, wherein the water content in the wetted cocoa nibs is equal to or less than the maximum amount of water than can be physically absorbed by the cocoa nibs.

35. The process of claim 32, wherein the cocoa nibs are ground and shaped in one operational step in a pelletizer or an extruder.

36. The process of claim 35, wherein the temperature during the grinding and shaping is below 100° C.

37. The process of claim 32, wherein the shaped agglomerated cocoa particles are dried during roasting.

38. The process of claim 32, wherein the water content at any time during the roasting is at least 0.5 wt % and the water activity value is at least 0.05.

39. The process of claim 32, wherein the water content at any time during the roasting is at least 1 wt % and the water activity value is at least 0.1.

40. The process of claim 32, wherein the temperature of the roasting is between 80° C. and 120° C.

41. The process of claim 32, wherein the shaped agglomerated cocoa particles have a cylindrical shape with a diameter of between 1 and 5 millimeters (mm) and wherein the average particle size of the cocoa nibs is reduced by at least 50%.

42. The process of claim 41, wherein the length of the shaped agglomerated cocoa particles is between 3 and 10 mm.

43. The process of claim 32, wherein the cocoa nibs are shaped in a die having cylindrical holes with a compression of between 3 and 30, wherein compression is defined as the ratio of the length over the diameter of a cylindrical hole.

44. The process of claim 32, wherein the cocoa nibs are ground and shaped in one operational step in a pelletizer, wherein the pelletizer comprises a die with holes having a compression of between 5 and 25 and a diameter of between 2 and 4 mm.

45. The process of claim 44, wherein the holes in the die have a conically shaped entry opening.

46. The process of claim 45, wherein the conically shaped entry opening is at least 0.5 mm in diameter and possesses an angle with the holes' cylindrical axis of between 30 and 75°.

47. The process of claim 32, wherein the cocoa nibs or shaped agglomerated cocoa particles are contacted with a base for alkalizing the cocoa.

48. The process of claim 47, wherein the base is added with the water in the wetting of the cocoa nibs before grinding and shaping.

49. The process of claim 47, wherein the shaped agglomerated cocoa particles containing the base are kept at a temperature of between 50 and 120° C. for a time sufficient to at least partially complete the alkalizing reaction and are subsequently roasted at a temperature of between 80 and 160° C.

50. A shaped agglomerated cocoa particle obtained by the process of claim 32.

51. The shaped agglomerated cocoa particle of claim 50, wherein the particles have a cylindrical shape with a diameter of between 2 to 5 mm and a length of between 3 and 10 mm.

52. The shaped agglomerated cocoa particle of claim 50, wherein the acrylamide content is below 200 parts per billion (ppb).

53. A process for the manufacture of cocoa liquor for use in making cocoa powder, cocoa butter or chocolate products, wherein the roasted shaped agglomerated cocoa particles of the process of claim 32 are subjected to grinding at elevated temperature to release the cocoa butter.

54. The process of claim 53, wherein the decrease in Q value caused by alkalizing is less than 0.02° C./min, wherein Q is the tangent of the crystallization peak in a cooling curve when temperature as a function of time is determined according to Method ICA No. 31.

55. Cocoa liquor obtained by the process of claim 53.

56. The cocoa liquor of claim 55, wherein the acrylamide content is below 200 parts per billion (ppb).

57. Chocolate products comprising the cocoa liquor of claim 55.

58. Cocoa butter obtained by the process of claim 47, wherein the cocoa butter has a Q value of at least 0.15° C./min.

59. The cocoa butter of claim 58, wherein the cocoa butter has a Q value of less than 50% below the Q value of natural cocoa butter obtained by the same process but without alkalization.

60. The cocoa butter of claim 58, wherein a decrease in the Q value of the cocoa butter is less than 20% of a decrease in the Q value of the cocoa nibs.

61. Chocolate products comprising the cocoa butter of claim 58.

62. Cocoa powder obtained by the process of claim 47, wherein the cocoa powder has an Oetker value of at least 1.0, wherein the Oetker value=a−0.2×(L+29.7), wherein L, a and b are color characteristic values determined by measuring the color of the Cocoa powder in a Hunter color analyzer.

63. The cocoa powder of claim 62, wherein the acrylamide content is below 200 parts per billion (ppb).

64. Chocolate products comprising the cocoa powder of claim 62.
